(19) United States
(12) Patent Application Publication
(10) Pub. No.: US 2020/0403676 A1
(43) Pub. Date: Dec. 24, 2020

(54) METHOD OF CHANNEL STATE INFORMATION (CSI) REPORTING IN WIRELESS COMMUNICATION SYSTEM

(71) Applicant: NTT DOCOMO, INC., Tokyo (JP)

(72) Inventors: Yuichi Kakishima, Tokyo (JP); Satoshi Nagata, Tokyo (JP); Li Huiling, Tokyo (JP); Chongning Na, Tokyo (JP); Xin Wang, Tokyo (JP)

(73) Assignee: NTT DOCOMO, INC., Tokyo (JP)

(21) Appl. No.: 16/961,084

(22) PCT Filed: Jan. 11, 2019
(86) PCT No.: PCT/US2019/013243

§ 371 Date: Jul. 9, 2020

Related U.S. Application Data
(60) Provisional application No. 62/616,272, filed on Jan. 11, 2018.

(51) Int. Cl. H04B 7/06; H04L 5/00; H04W 72/12; H04W 72/04

(52) U.S. Cl. CPC H04B 7/0626; H04L 5/0051; H04W 72/0446; H04B 7/0639; H04W 72/1263; H04B 7/0632

(57) ABSTRACT

A method of Channel State Information (CSI) reporting in a wireless communication system includes receiving, with a user equipment (UE), CSI Reference Signals (CSI-RSs) from a base station (BS), calculating, with the UE, first parameters of Type I CSI and second parameters of Type II CSI based on the CSI-RS, and reporting, from the UE to the BS, Type I CSI including first parameters and Type II CSI including second parameters using a Physical Uplink Control Channel (PUCCH) based on the CSI-RSs. The first parameters and the second parameters are multiplexed in order of the second parameters and the first parameters or in order of high priority parameters of the first and second parameters and low priority parameters of the first and second parameters.

### TECHNICAL FIELD

One or more embodiments disclosed herein relate to a method of collision handling between Type I and Type II Channel State Information (CSI) in a wireless communication system.

### BACKGROUND

In a wireless communication system (e.g., New Radio (NR; fifth generation (5G) radio access technology)), Channel State Information (CSI) acquisition scheme is used for acquiring channel condition and facilitating network scheduling. CSI has Type I CSI and Type II CSI. Type I CSI and Type II The CSI are reported to provide different information with different functionality.

For example, if resources for a physical channel used for CSI reporting is not enough or collision cannot be avoided by scheduling, CSI reporting does not work. Further, how the Type I CSI and Type II CSI should be reported in insufficient resources or collision is not clarified.

### CITATION LIST

### Non-Patent Reference

[Non-Patent Reference 1] 3GPP, TS 36.211 V 14.3.0
[Non-Patent Reference 2] 3GPP, TS 36.213 V14.3.0

### SUMMARY

Embodiments of the present invention relate to a method of Channel State Information (CSI) reporting in a wireless communication system that includes receiving, with a user equipment (UE), CSI Reference Signals (CSI-RSs) from a base station (BS), calculating, with the UE, first parameters of Type I CSI and second parameters of Type II CSI based on the CSI-RS, and reporting, from the UE to the BS, Type I CSI including first parameters and Type II CSI including second parameters using a Physical Uplink Control Channel (PUCCH) based on the CSI-RSs. The first parameters and the second parameters are multiplexed.

Embodiments of the present invention relate to a method of CSI reporting in a wireless communication system that includes receiving, with a UE, CSI-RSs from a BS, calculating, with the UE, first parameters of Type I CSI and second parameters of Type II CSI based on the CSI-RS, and when different physical channels are used for reporting the Type I CSI and the Type II CSI reporting, respectively, reporting at least one of the Type I CSI and the Type II CSI to the BS. The different physical channels are a Physical Uplink Control Channel (PUCCH) and a Physical Uplink Shared Channel (PUSCH).

Embodiments of the present invention relate to a method of CSI reporting in a wireless communication system that includes receiving, with a UE, CSI-RSs from a BS, calculating, with the UE, first parameters of Type I CSI and second parameters of Type II CSI based on the CSI-RS, and scheduling, with the UE, Type I CSI and Type II CSI to avoid collision between Type I CSI reporting and Type II CSI reporting, and reporting, from the UE to the BS, the Type I CSI and Type II CSI.

Other embodiments and advantages of the present invention will be recognized from the description and figures.

### BRIEF DESCRIPTION OF THE DRAWINGS

FIG. 1 is a diagram showing a wireless communication system according to one or more embodiments of the present invention.

FIG. 2 is a diagram showing an example of contiguous carrier aggregation according to one or more embodiments of the present invention.

FIG. 3 shows two different types of CSIs reported by a UE to a gNB according to one or more embodiments of the present invention.

FIG. 4 is a flowchart diagram showing an example operation of a UE according to one or more embodiments of the present invention.

FIG. 5 is a flowchart diagram showing an example operation of a UE according to one or more embodiments of the present invention.

FIG. 6 is a flowchart diagram showing an example operation of a UE according to one or more embodiments of the present invention.

FIG. 7 is a diagram showing a schematic configuration of a gNB according to one or more embodiments of the present invention.

FIG. 8 is a diagram showing a schematic configuration of a UE according to one or more embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

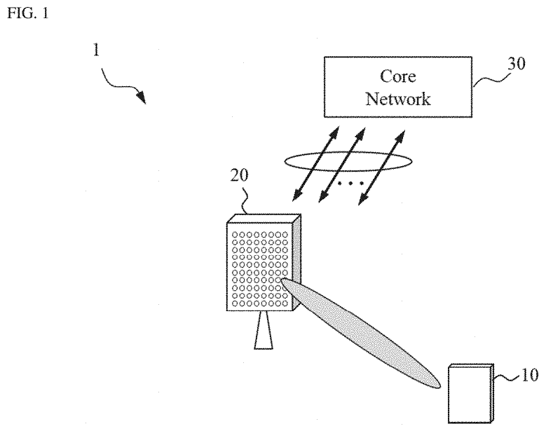

FIG. 1 is a diagram showing a wireless communication system 1 according to one or more embodiments of the present invention. The wireless communication system 1 may be a New Radio (NR) system.

The wireless communication system 1 includes a user equipment (UE) 10, a gNodeB (gNB) 20, and a core network 30. The wireless communication system 1 is not limited to the specific configurations described herein and may be any type of wireless communication system such as an LTE/LTE-Advanced (LTE-A) system. The wireless communication system 1 may support a method of collision handling between Type I and Type II Channel State Information (CSI).

The gNB 20 may be a station that communicates with the UE 10 and may also be referred to as a base station (BS), a transmission and reception point (TRP), and an access point, etc. The gNB 20 may provide a communication coverage are for a particular geographic area, which may be referred to as a cell.

The gNB 20 includes antennas, a communication interface to communicate with an adjacent gNB 20 (for example, X2 interface), a communication interface to communicate with the core network 30 (for example, S1 interface), and a CPU (Central Processing Unit) such as a processor or a circuit to process transmitted and received signals with the UE 10. Operations of the gNB 20 may be implemented by the processor processing or executing data and programs stored in a memory. However, the gNB 20 is not limited to the hardware configuration set forth above and may be realized by other appropriate hardware configurations as understood by those of ordinary skill in the art. Numerous gNBs 20 may be disposed so as to cover a broader service area of the wireless communication system 1.

The UE 10 may be dispersed throughout the wireless communication system 1, and each UE 10 may be stationary or mobile. The UE 10 may be referred to as a terminal, a mobile station, a subscriber unit, or a station. The UE 10 may be a cellular phone, a smartphone, a tablet, a sensor, a personal digital assistant (PDA), a wireless modem, a netbook, a smartbook, a wireless communication device, a handheld device, a laptop computer, a cordless phone, a wireless local loop (WLL) station, or information processing apparatus having a radio communication function such as a wearable device. The UE10 may communicate with the gNB(s) 20.

The UE 10 includes a CPU such as a processor, a RAM (Random Access Memory), a flash memory, and a radio communication device to transmit/receive radio signals to/from the gNB 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

In the wireless communication system 1, uplink (UL) communication may indicate communication from the UE 10 to the gNB 20. Downlink (DL) communication may indicate communication from the gNB 20 to the UE 10. Each gNB 20 includes at least a radio frequency transmitter and at least a receiver used to communicate with the UE, which may move freely around it. Similarly, each UE 10 includes at least a radio frequency transmitter and at least a receiver used to communicate with the gNB 20.

In one or more embodiments of the present invention, use of multiple antennas at both a transmission point (e.g., gNB 20 or UE 10) and a reception point (e.g., UE 10 or gNB 20) in the wireless communication system 1 along with related baseband signal processing may be referred to as Multiple-Input Multiple-Output (MIMO) technology. In a MU-MIMO system, precoding is applied at the transmission point in order to suppress mutual interference experienced by each reception point caused by transmissions to other reception points. MU-MIMO precoding is spatial encoding of the transmitted signal based on propagation channel. In order to apply MU-MIMO precoding, the transmission point is required to know Channel State Information (CSI) of radio channels connecting the transmission point to each of the reception point for transmission. In the wireless communication system 1, the reception point (e.g., UE 10) may measure CSI and report the measured CSI to the transmission point (e.g., gNB 20) via an UL feedback channel. The reporting CSI may be referred to as CSI feedback. The CSI feedback includes at least one of a CSI-Reference Signal (CSI-RS) Resource Indicator (CRI), a Reference Signal Received Power (RSRP) value, a Rank Indicator (RI), a Precoding Matrix Indicator (PMI), a Channel Quality Indicator (CQI) for each DL component channel (CC).

In one or more embodiments of the present invention, several types of physical channels are used for the DL transmission in the wireless communication system 1. The physical channels may convey information from higher layers in the 5G stack. In contrast to physical signals, the physical channels may convey information that is used exclusively within the physical (PHY) layer. For example, the DL physical channels may be a PDSCH, a Physical Broadcast Channel (PBCH), a Physical Multicast Channel (PMCH), a Physical Control Format Indicator Channel (PCFICH), a PDCCH, and a Physical Hybrid ARQ Indicator Channel (PHICH). For example, UL physical channels may be a Physical Uplink Shared Channel (PUSCH) and a PUCCH.

In one or more embodiments of the present invention, the wireless communication system 1 may utilize at least one of a Frequency Division Duplex (FDD) mode and a Time Division Duplex (TDD) mode. In the FDD mode, a DL channel and a UL channel may be allocated to different frequency channels, respectively, and DL transmissions and UL transmissions may be performed concurrently on the two frequency channels. In the TDD mode, a DL channel and an DL channel may share the same frequency channel, and DL transmissions and UL transmissions may be transmitted on the same frequency channel in different time periods.

For both of the FDD and TDD modes, a subframe used for the DL may be referred to as a DL subframe. A subframe used for the UL may be referred to as an UL subframe. A CC configured for the FDD mode may be referred to as an FDD CC. A CC configured for TDD may be referred to as a TDD CC. A subframe can be called a slot.

For both of the FDD and TDD modes, at least one of a Physical Downlink Control Channel (PDCCH) and other physical channels may be transmitted in a control region of a DL subframe with in the cell. The PDCCH may carry DL control information (DCI) such as DL grants, UL grants, etc. The cell may also transmit a Physical Downlink Shared Channel (PDSCH) and/or other physical channels in a data region of a DL subframe. The PDSCH may carry data for UEs scheduled for data transmission on the DL.

For both of the TDD and FDD modes, the UE 10 may transmit either the PUCCH in a control region of an UL subframe or the PUSCH in a data region of the UL subframe. For example. the PUCCH may carry channel state information (CSI) that indicates a channel state of the DL, and scheduling request. The PUSCH may carry at least one of user data and the CSI.

The wireless communication system 1 may support operations with multiple CCs, which may be referred to as carrier aggregation (CA) or multi-carrier operation. The UE 10 may be configured with multiple CCs for the DL and one or more CCs for the UL for carrier aggregation. The gNB 20 may transmit data and downlink control information (DCI) on one or more CCs to the UE 10. The UE 10 may transmit data and CSI on one or more CCs to the gNB 20.

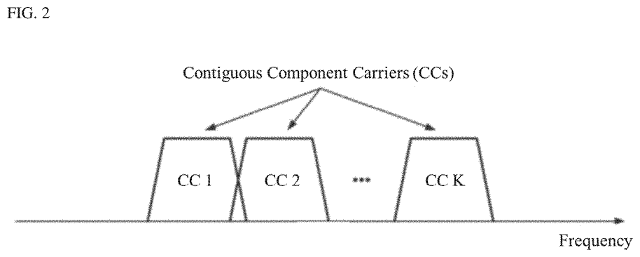

FIG. 2 shows an example of contiguous carrier aggregation according to one or more embodiments of the present invention. In FIG. 2, K CCs may be available for communication and may be adjacent to each other, where K may be any integer value.

The UE 10 may transmit CSI to the gNB 20 to support data transmission on the downlink. The CSI may include channel quality indicator (CQI), precoding matrix indicator (PMI), channel direction indication (CDI), precoding type indicator (PTI), rank indicator (RI), Layer Index or Information (LI) and/or other information. RI may indicate the number of layers to use for data transmission. Each layer may be viewed as a spatial channel. The PTI may indicate a precoding type feedback, e.g., wideband versus subband. The PMI may indicate a precoding matrix or vector to use for precoding data prior to transmission. The CDI may indicate a spatial direction (e.g., a dominant eigenvector) for transmitting data. The CQI may indicate a channel quality for each of at least one packet to transmit. The CSI may also include other information used to transmit data.

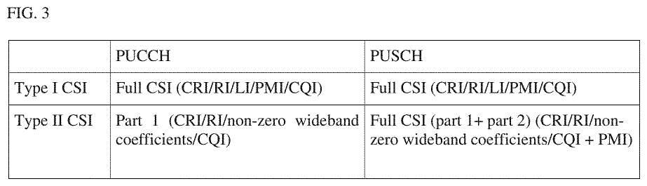

FIG. 3 shows two different types of CSIs reported by the UE 10 to the gNB 20. The CSI types have Type I CSI and Type II CSI. The Type I CSI and Type II CSI may be reported using at least one of PUCCH and PUSCH. As shown in FIG. 3, the Type I CSI parameters reported on the PUCCH include the CRI/RI/LI/PMI/CQI. The Type II CSI parameters reported on the PUCCH include the CRI/RI/non-zero wideband coefficients/CQI. The Type I CSI parameters reported on the PUSCH include the CRI/RI/LI/PMI/CQI. The Type II CSI parameters reported on the PUSCH include the CR/RI/non-zero wideband coefficients/CQI and the PMI.

According to one or more embodiments of the present invention, transmission of CSI from the UE 10 may be referred to as CSI reporting or CSI feedback.

One or more embodiments of the present invention provide methods of CSI reporting for Type I and Type II CSI collision handling for the following cases:
Case 1: Type I CSI and Type II CSI are configured on PUCCH only, with sufficient PUCCH capacity;
Case 2: Type I CSI and Type II CSI are configured on PUCCH and PUSCH separately; and
Case 3: Type I CSI and Type II CSI reporting does not collide.

For Case 1, Type I CSI and Type II CSI are reported to provide different information with different functionality. Type I CSI reporting is used for for single beam based full CSI information feedback, while Type II CSI reporting on the PUCCH is used for multiple beams based CSI reporting, and only part of Type II CSI can be reported on the PUCCH, which can be used to help PUSCH resource allocation for full Type II CSI reporting. One or more embodiments of the present invention provide CSI parameter multiplexing schemes when both Type I and Type II CSI parameters are reported on the PUCCH.

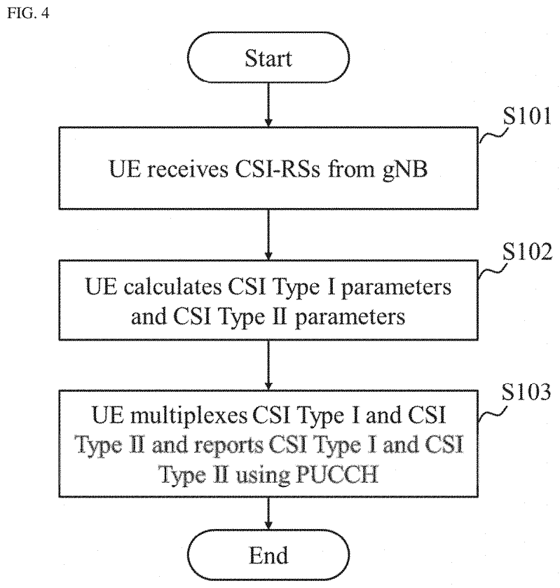

FIG. 4 is a flowchart diagram showing an example operation of the UE 10 according to one or more embodiments of the present invention. when the UE 10 receives CSI-RSs from the gNB 20 (S101), the UE 10 calculates Type I CSI parameters and Type II CSI parameters based on the received CSI-RSs (S102). Then, the UE 10 reports Type I CSI including the Type I CSI parameters and Type II CSI including the Type II CSI parameters using the PUCCH to the gNB 20 (S103). When the Type I CSI and the Type II CSI are simultaneously reported, the Type I CSI parameters and the Type II CSI parameters are multiplexed.

For example, the Type I CSI parameters and the Type II CSI parameters are multiplexed in order of the Type II CSI parameters and the Type I CSI parameters.

For example, the Type I CSI parameters include the CRI, the RI, the LI, the PMI, and the CQI. The Type II CSI parameters include the CR, the RI, the non-zero wideband coefficients, and the CQI.

As another example, the Type I CSI parameters and the Type II CSI parameters are multiplexed in order of high priority parameters of the Type I and Type II CSI parameters and low priority parameters of the Type I and Type II CSI parameters. For example, the Type I CSI parameters and the Type II CSI parameters are multiplexed in order of the CRI and the RI of the Type II CSI parameters, the CRI and the RI of the Type I CSI parameters, the LI of the Type II CSI parameters, the non-zero wideband coefficients of the Type II CSI parameters, the CQI of the Type I CSI parameters, the PMI of the Type I CSI parameters, and the CQI of the Type I CSI parameters.

For Case 2, when both Type I and Type II CSI are configured and are separately carried by PUCCH and PUSCH. One or more embodiments of the present invention provide CSI dropping scheme/CSI multiplexing scheme. When one type of CSI is dropped, it reduces CSI payload, lowering code rate, thus reducing PUCCH propagation error. Another way is to report both Type I and Type II CSI. When two of them are to be reported, two functionalities can be realized simultaneously, which can provide plentiful information to the gNB 20 for better scheduling. For CSI parameter multiplexing on PUCCH or PUSCH, it provides methods for CSI parameter order to avoid confusion.

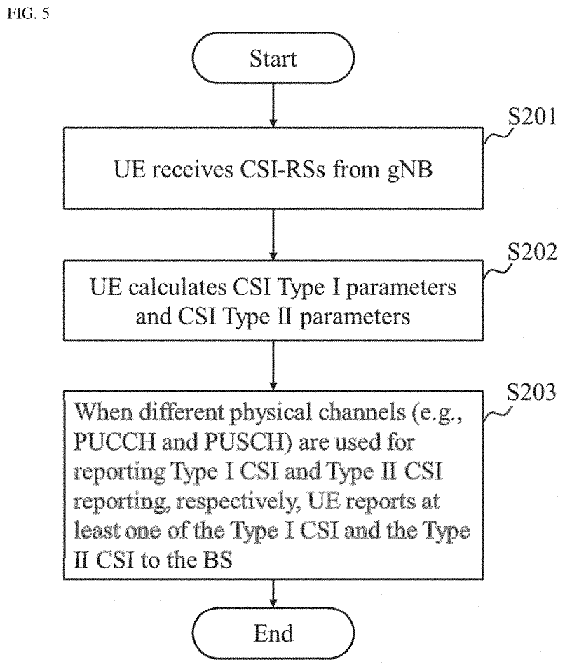

FIG. 5 is a flowchart diagram showing an example operation of the UE 10 according to one or more embodiments of the present invention. When the UE 10 receives CSI-RSs from the gNB 20 (S201), the UE 10 calculates Type I CSI parameters and Type II CSI parameters based on the received CSI-RSs (S202). When different physical channels are used for reporting the Type I CSI and the Type II CSI reporting, respectively, the UE 10 reports at least one of the Type I CSI and the Type II CSI to the gNB 20 (S203). For example, the different physical channels are a PUCCH and a PUSCH.

For example, when the PUCCH is used for reporting the Type I CSI and the PUSCH is used for reporting the Type II CSI, the UE 10 reports the Type II CSI.

For example, when the PUCCH is used for reporting the Type I CSI and the PUSCH is used for reporting the Type II CSI, the UE 10 reports the Type I CSI and the Type II CSI.

For example, when the PUSCH is used for reporting the Type I CSI and the PUCCH is used for reporting the Type II CSI, the reporting reports the Type II CSI.

For example, when the PUSCH is used for reporting the Type I CSI and the PUCCH is used for reporting the Type II CSI, the UE 10 reports the Type I CSI and the Type II CSI.

For Case 3, Type I and Type II CSI reporting are not expected to collide, with the help of scheduling from resource allocation or periodicity and time offset setting.

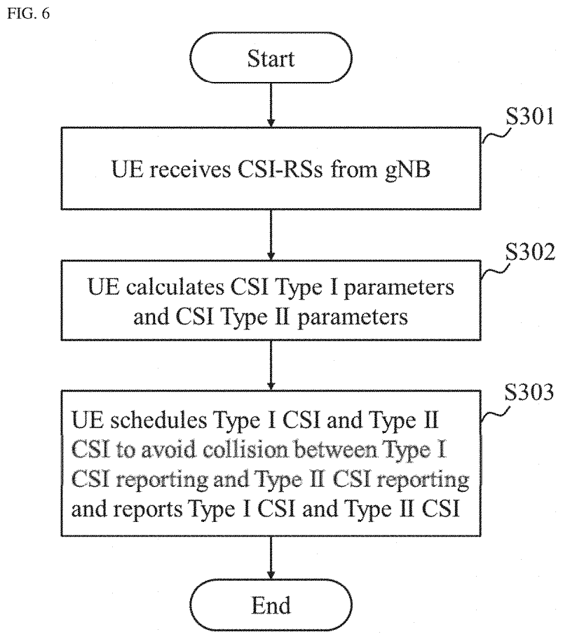

FIG. 6 is a flowchart diagram showing an example operation of the UE 10 according to one or more embodiments of the present invention. When the UE 10 receives CSI-RSs from the gNB 20 (S301), the UE 10 calculates Type I CSI parameters and Type I CSI parameters based on the received CSI-RSs (S302). The UE 10 schedules Type I CSI and Type H CSI to avoid collision between Type I CSI reporting and Type II CSI reporting, and reports, to the gNB 20, the Type I CSI and Type II CSI (S303).

For example, in the scheduling, the UE 10 may not expect to receive a configuration where the Type I CSI and the Type II CSI will be reported in the same PUCCH.

For example, in the scheduling, the UE 10 may not expect to receive a configuration where the Type I CSI and the Type II CSI will be reported in the same slot.

(Configuration of gNB)

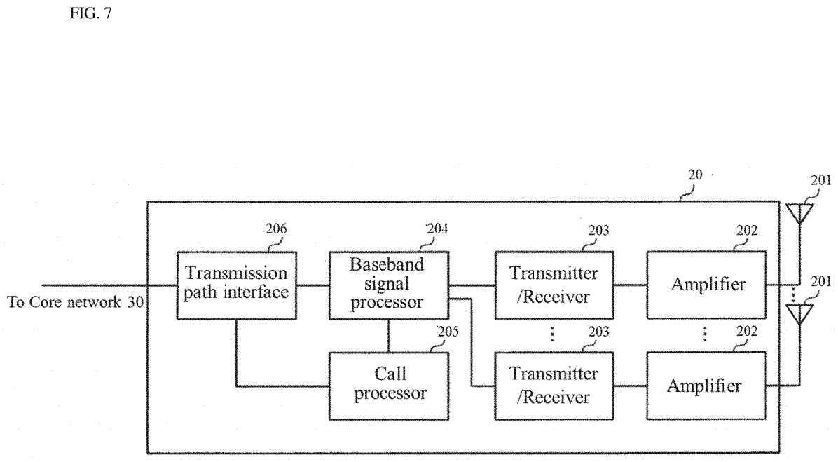

The gNB 20 according to one or more embodiments of the present invention will be described below with reference to FIG. 7. FIG. 7 is a diagram illustrating a schematic configuration of the gNB 20 according to one or more embodiments of the present invention. The gNB 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the gNB 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, MAC retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the gNB 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the gNB 20, and manages the radio resources.

(Configuration of User Equipment)

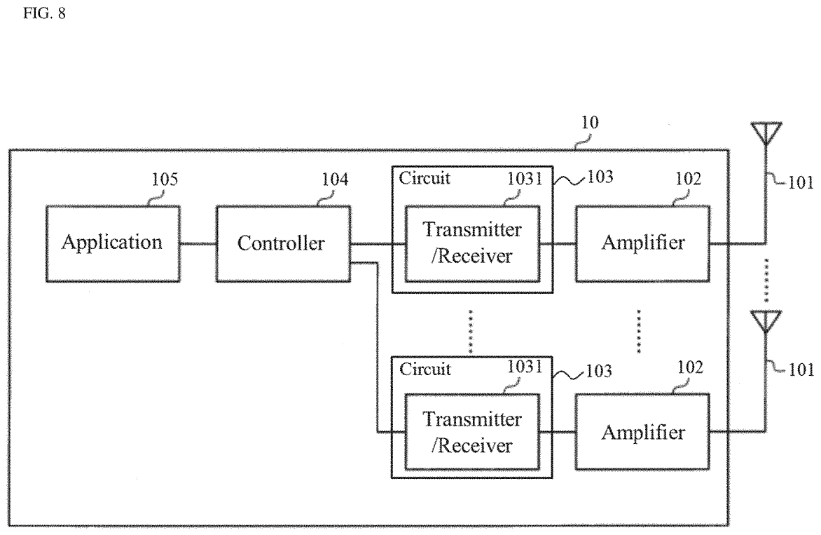

The UE 10 according to one or more embodiments of the present invention will be described below with reference to FIG. 8. FIG. 8 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

Although the present disclosure mainly described examples of a channel and signaling scheme based on NR, the present invention is not limited thereto. Embodiments of the present invention may apply to another channel and signaling scheme having the same functions as NR such as LTE/LTE-A and a newly defined channel and signaling scheme.

Although the present disclosure described examples of various signaling methods, the signaling according to embodiments of the present invention may be explicitly or implicitly performed.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

A presentation is attached as an Appendix to further describe embodiments of the present invention.

What is claimed is:

1. A method of Channel State Information (CSI) reporting in a wireless communication system, the method comprising:
receiving, with a user equipment (UE), CSI Reference Signals (CSI-RSs) from a base station (BS);
calculating, with the UE, first parameters of Type I CSI and second parameters of Type II CSI based on the CSI-RS; and
reporting, from the UE to the BS, Type I CSI including first parameters and Type II CSI including second parameters using a Physical Uplink Control Channel (PUCCH) based on the CSI-RSs,
wherein the first parameters and the second parameters are multiplexed.

2. The method according to claim 1, wherein the first parameters and the second parameters are multiplexed in order of the second parameters and the first parameters.

3. The method according to claim 1, wherein the first parameters and the second parameters are multiplexed in order of high priority parameters of the first and second parameters and low priority parameters of the first and second parameters.

4. The method according to claim 1,
wherein the first parameters include a CSI-RS Resource Indicator (CRI), a Rank Indicator (RI), a Layer Index (LI), a Precoding Matrix Indicator (PMI), and a Channel Quality Indicator (CQI),
wherein the second parameters include a CRI, an RI, non-zero wideband coefficients, and a CQI.

5. The method according to claim 4, wherein the first parameters and the second parameters are multiplexed in order of the CRI and the RI of the second parameters, the CRI and the RI of the first parameters, the LI of the second parameters, the non-zero wideband coefficients, the CQI of the first parameters, the PMI of the first parameters, and the CQI of the first parameters.

6. A method of Channel State Information (CSI) reporting in a wireless communication system, the method comprising:
receiving, with a user equipment (UE), CSI Reference Signals (CSI-RSs) from a base station (BS);
calculating, with the UE, first parameters of Type I CSI and second parameters of Type II CSI based on the CSI-RS; and
when different physical channels are used for reporting the Type I CSI and the Type II CSI reporting, respectively, reporting at least one of the Type I CSI and the Type H CSI to the BS,
wherein the different physical channels are a Physical Uplink Control Channel (PUCCH) and a Physical Uplink Shared Channel (PUSCH).

7. The method according to claim 6, wherein when the PUCCH is used for reporting the Type I CSI and the PUSCH is used for reporting the Type II CSI, the reporting reports the Type II CSI.

8. The method according to claim 6, wherein when the PUCCH is used for reporting the Type I CSI and the PUSCH is used for reporting the Type II CSI, the reporting reports the Type I CSI and the Type II CSI.

9. The method according to claim 6, wherein when the PUSCH is used for reporting the Type I CSI and the PUCCH is used for reporting the Type II CSI, the reporting reports the Type II CSI.

10. The method according to claim 6, wherein when the PUSCH is used for reporting the Type I CSI and the PUCCH is used for reporting the Type II CSI, the reporting reports the Type I CSI and the Type II CSI.

11. A method of Channel State Information (CSI) reporting in a wireless communication system, the method comprising:
receiving, with a user equipment (UE), CSI Reference Signals (CSI-RSs) from a base station (BS);
calculating, with the UE, first parameters of Type I CSI and second parameters of Type II CSI based on the CSI-RS; and
scheduling, with the UE, Type I CSI and Type II CSI to avoid collision between Type I CSI reporting and Type II CSI reporting; and
reporting, from the UE to the BS, the Type I CSI and Type II CSI.

12. The method according to claim 11, wherein in the scheduling, the UE does not expect to receive a configuration where the Type I CSI and the Type II CSI will be reported in a same PUCCH.

13. The method according to claim 11, wherein in the scheduling, the UE does not expect to receive a configuration where the Type I CSI and the Type II CSI will be reported in a same slot.
